(19) United States
(12) Patent Application Publication
(10) Pub. No.: US 2023/0302761 A1
(43) Pub. Date: Sep. 28, 2023

(54) RECYCLABLE FABRIC LAMINATE

(71) Applicant: INV Performance Materials, LLC, Wilmington, DE (US)

(72) Inventors: Laura E. Pritchard, Kingston (CA); Sundar Mohan Rao, Chattanooga, TN (US); Subhash Chand, Rosewell, GA (US)

(21) Appl. No.: 18/122,713

(22) Filed: Mar. 17, 2023

Related U.S. Application Data
(60) Provisional application No. 63/322,413, filed on Mar. 22, 2022.

(51) Int. Cl. B32B 5/02; B32B 7/10; B32B 7/12; B32B 37/04; B32B 38/00

(52) U.S. Cl. CPC B32B 5/02; B32B 7/10; B32B 7/12; B32B 37/04; B32B 38/0008; B32B 2250/00; B32B 2367/00; B32B 2377/00; B32B 2323/00; B32B 2375/00; B32B 2307/7265

(57) ABSTRACT

A composition may comprise a fabric substrate having a first melting temperature and a polymer sheet having a second melting temperature, wherein the second melting temperature may be less than the first melting temperature. The polymer sheet and the fabric substrate may have a base thermoplastic polymer in common. The polymer sheet may be at least partially melted and laminated onto the fabric substrate such that the polymer sheet and fabric substrate become fused to produce a fused laminated fabric. A recycling process may be performed on the fused laminated fabric, wherein the fabric substrate and the polymer sheet remain laminated throughout the recycling process.

### CROSS-REFERENCE TO RELATED APPLICATION

This application claims the priority of U.S. provisional application Ser. No. 63/322,413, filed Mar. 22, 2022, the disclosure of which is incorporated herein by reference in its entirety.

### TECHNICAL FIELD

This document pertains generally, but not by way of limitation, to mono-material fabric for constructing various articles of consumer utility with full recyclability and circularity. In particular, the present disclosure uses recycle-compatible materials in the construction of a laminated fabric.

### BACKGROUND

Most apparel and other articles made of fabrics at the end of their life currently go to a landfill. These articles have multiple materials in their construction. Recycling of these products is not possible because they are composed of various components with multiple polymers that would have to be separated for recycling, which is cost prohibitive and for some fabrics, separation is not possible with mechanical processes. Use of adhesives to bond together multiple layers fabrics causes further difficulty with recycling. Recycling products to create new products is the aim of a circular economy that retail brand customers are working towards. Current product material compositions do not meet such circularity objectives.

Fabrics such as clothing, bags, and backpacks that need to be waterproof use fabrics such as nylon that are often coated with polyurethane. Woven nylon fabrics are slightly porous and therefore not fully waterproof. Industry standard is to use polyurethane coating applied to the woven nylon fabric. However, such polyurethane coated nylon fabric interferes with the recyclability of the fabric because polyurethane and nylon are not compatible materials. While the performance of such polyurethane coated nylon fabrics against water leakage is adequate, polyurethane cannot be easily separated from the fabric during sorting and recycling processes. Other processes to make a fabric waterproof include use of a thermoplastic elastomer (TPE) or thermoplastic polyester elastomer (TPEE) to bond to the woven nylon fabric. The bonding of TPE or TPEE to the woven nylon fabric may be accomplished using heat and pressure or most commonly by adhesives. The resulting waterproof fabric also needs to be separated before it can be recycled and hence the bonding is designed to be weak enough so they can be separated. If separation is not possible, material is sent to landfill as the materials are not compatible with each other for recycling.

### SUMMARY/OVERVIEW

The present disclosure relates to fused laminated fabrics for constructing various articles of consumer utility that are recyclable by conventional mechanical recycling processes such as cutting, shredding, remelting, and pelletizing. Such articles may also be easier to be recycled by various chemical recycling processes. The fused laminated fabric may be reusable as a feedstock for creating new in-kind products, such as films for packaging, fibers and fabrics, and injection molded articles. Compatible materials may be used in the construction of the fused laminated fabric without using adhesives of different materials such that the fused laminated fabric is free of external adhesive. The fused laminated fabric eliminates the need for sorting or separation during a recycling process, avoids non-recyclable component materials from going to a landfill, and reduces the consumption of resources including raw materials, energy, and water.

In some embodiments, the fused laminated fabric may comprise components of the same type of polymer. It may be practical and feasible to use the same type of polymer for multiple components applied to the fused laminated fabric, such as buttons, zippers, straps, and buckles in construction of articles. The fused laminated fabric may be recycled without separation of its components and may have features needed for the articles including waterproofing and abrasion resistance.

Various embodiments of the fused laminated fabric may comprise a fabric substrate and a polymer sheet. The polymer sheet includes a hot melt adhesive, a film, web, a resinous sheet, or a combination thereof. The fabric substrate and the polymer sheet may have a base thermoplastic polymer in common such that the fused laminated fabric is a mono-material and may be recycled without separation of its components. For example, in one embodiment, the selected fabric substrate may comprise a polyester or a polyester copolymer and the compatible polymer sheet may comprise a hot melt adhesive polymer that includes a polyester. Examples of polyester hot melt adhesives may include saturated thermoplastic polyester resins manufactured by a condensation reaction between acids or anhydrides like phthalic anhydride, isophthalic acid, adipic acid and glycols (polyols) like propylene glycol, diethylene glycol, glycerine, and neopentyl glycol. The length of the diol chain may impact the adhesive properties. For example, increasing diol chain length may decrease the melting point, glass transition temperature, and the degree of crystallinity. Other monomers to make such a hot melt adhesive could include a polycarboxylic acid component, alicyclic dicarboxylic acid component, an aromatic dicarboxylic acid and a polyhydric alcohol component.

In another embodiment, the fabric substrate may comprise a polyolefin and the compatible polymer sheet may comprise a hot melt adhesive polymer that includes a polyolefin, a polyolefin-based copolymer and a polyolefin-based terpolymer. The fused laminated fabric may be a polyolefin hot melt adhesive polymers fusion bonded with a polyolefin fabric substrate to provide performance attributes while making the composite recyclable through a mechanical process. Examples of polyolefin hot melt adhesive polymers include Amorphous polyolefin, Amorphous atactic polypropylene, Amorphous polypropylene/Ethylene copolymer, Amorphous polypropylene/Hexene copolymer, Amorphous polypropylene/Ethylene/Butene terpolymer, LDPE, LLDPE, MDPE, HDPE, Ethylene Vinyl Acetate, Ethylene Methyl Acrylate, Ethylene Butyl Acrylate, or blends thereof.

The fabric substrate may comprise co-polymers or co-monomers. For example, the fabric substrate may comprise Nylon 66 fabrics that include co-polymers of Nylon 66 using INVISTA DYTEK® A amine, Isophthalic acid, and caprolactam, as co-monomers. In one embodiment, the fabric substrate may comprise a Nylon 66/6/11 co-polymer. The form of the fabric substrate may comprise a membrane, non-woven fabric, plain-woven fabric, knitted fabric, fibrous sheet, blended yarn fabric, three-dimensional fabric, embossed fabric, a film, or a resinous sheet. In various embodiments, the fabric substrate may comprise polyethylene terephthalate, polybutylene terephthalate, polytrimethylene terephthalate, thermoplastic polyurethane, polypropylene, polyethylene, or thermoplastic polyamide.

In another embodiment, the fabric substrate may comprise a Nylon 66 polymer, a Nylon 66 co-polymer, a Nylon 6 polymer, a Nylon 6 co-polymer, a Nylon 10 polymer, a Nylon 10 co-polymer, a Nylon 12 polymer, a Nylon 12 co-polymer, a Nylon 11 polymer, or a Nylon 11 co-polymer, or a blend thereof, and the compatible polymer sheet may comprise a hot melt adhesive polymer that includes nylon.

In some embodiments, the fabric substrate may comprise polyamides, including Nylon 6, and co-polymers thereof. Polyamide hot melt adhesives may be used for full fusion bonding to Nylon 6,6 or Nylon 6 fabric substrates. In one embodiment, the hot melt adhesive polymer may comprise a polyamide layer of a dimer acid with two or more different diamines. Linear aliphatic amines such as ethylene diamine and hexamethylene diamine [HMD], may provide hardness and strength. The most common monomers for hot melt polyamides are dibasic acids, dimer acid (dimerized fatty acids), dodecanedioic acid, sebacic acid, azelaic acid, adipic acid, amino acids, lactams including caprolactam, 11-aminoundecanoic acid, dodecalactam, diamines including ethylene diamine, hexamethylene diamine, diethylene triamine, triethylene tetramine, piperazine, dipiperidyl propane (dipip), and polyoxypropylene diamine. Such hot melt adhesives polymers in the form of films may be fully bonded with nylon fabric to provide abrasion and water resistance, while making the composite fully recyclable through a mechanical process.

Examples of compositions of polyamide hot melt adhesives with partial aromatic content and their corresponding melting temperatures are shown in Table 1 below. Even with aromatic acid components, low melting compositions can be obtained. However, in some embodiments, the proportion of aromatic diacids may not be greater than approximately 10 mol %.

TABLE 1

| Monomer Feed | mol % | | | | | |
|---|---|---|---|---|---|---|
| Caprolactam | 30 | 25 | 27 | 30 | 30 | 40 |
| Laurolactam | 40 | 50 | 40 | 50 | 40 | 40 |
| Adipic acid | 10 | — | 3 | — | — | 20 |
| Azelaic acid | 10 | — | 11 | — | 15 | — |
| Sebacic acid | 10 | 19 | 10 | — | 15 | — |
| Dodecane diacid | — | — | — | 20 | — | — |
| Terephthalic acid | — | 6 | 9 | — | — | — |
| HMD | 25 | 20 | 25 | — | — | 20 |
| Piperazine | 5 | — | — | 20 | — | — |
| 2-Methylpentane- | — | 5 | 8 | — | 30 | — |
| diamine | | | | | | |
| RV(dlg-1)ª | 1.37 | 1.36 | 1.34 | 1.41 | 1.38 | 1.35 |
| Melting Point | 104 | 100 | 79 | 113 | 109 | 121 |
| (° C.) | | | | | | |

The fabric substrate may have a first melting temperature and the polymer sheet may have a second melting temperature, wherein the second melting temperature is less than the first melting temperature. Fusion of the laminated fabric may be done by a fusion-bonding process in which the polymer sheet may be at least partially melted and applied to the fabric substrate, embedding into the fibers of the fabric substrate in the fusion-bonding process. In various embodiments, the polymer sheet may have a second melting temperature in a range from approximately 10° C. to approximately 200° C. lower than the first melting temperature of the fabric substrate. For example, the polymer sheet may have a second melting temperature in a range from approximately from 10° C. to approximately 200° C. lower than the first melting temperature of the fabric substrate. In another example, the polymer sheet may have a second melting temperature in a range from approximately from 25° C. to approximately 190° C. lower than the first melting temperature of the fabric substrate. In another example, the polymer sheet may have a second melting temperature in a range from approximately from 25° C. to approximately 180° C. lower than the first melting temperature of the fabric substrate. In another example, the polymer sheet may have a second melting temperature in a range from approximately from 30° C. to approximately 175° C. lower than the first melting temperature of the fabric substrate.

In various embodiments, the polymer sheet may be a fraction of thickness, or a weight as compared to the fabric substrate to optimize its recyclability. For example, the polymer sheet may comprise approximately 1% by weight to approximately 40% by weight of the fused laminated fabric. For example, in some embodiments, the polymer sheet may comprise approximately 2% by weight to approximately 25% by weight of the fused laminated fabric, or approximately 3% by weight to approximately 15% by weight of the fused laminated fabric. The thickness of the polymer sheet may be approximately 0.1 mil to approximately 20 mil, from approximately 0.5 mil to approximately 10 mil, or approximately 1 mil to approximately 5 mil, wherein one mil is equal to 25.4 microns or 0.0254 mm. The minimum melt temperature of the polymer sheet can be approximately 60° C. For example, the minimum melt temperature can be approximately 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., or 100° C.

In various embodiments, the hot melt adhesive polymer may be in the form of a film or a web. The hot melt adhesive polymer may be at least partially melted, extruded, and applied as liquid coating to the fabric substrate. In another embodiment, the hot melt adhesive polymer may be applied as a film and fusion-bonded to the fabric substrate to produce a fused laminated fabric. The fusion-bonding process may comprise any suitable process including hot pressing, hot air blowing, or high frequency bonding. The bonding heat and pressure conditions are such that the hot melt adhesive polymer layer may soften or melt at the interface of the fabric substrate, penetrating in the fabric substrate from underneath. The bonding process may also comprise corona or plasma or another treatment of fabric or polymer sheet or both prior to bonding. The fused laminated fabric may contain fibers from the fabric substrate and the hot melt adhesive polymer bonded together resulting in higher abrasion resistance and acceptable water leakage resistance (as determined by the water column testing).

The fusion bonding process may be performed by equipment such as calendaring equipment. The calendaring equipment may provide easy user handling of the hot melt adhesive polymer using existing installed calendaring equipment at fabric finishing mills. The calendaring equipment may provide a smooth outer surface of the hot melt adhesive polymer without need for a backing layer in product design and function. Calendaring machines with multiple rollers can be used for widths from 400 mm to 1600 mm or from 1850 mm to 6000 mm and reaching line speeds of up to 100 meters per minute. The bonding process may utilize heat, pressure, and time.

In another embodiment, the fusion bonding may utilize a hot iron to hot press or laminate the hot melt adhesive polymer onto a face of the fabric substrate. Any suitable laminating processes may be used on a larger scale to perform fusion bonding. For example, commercial laminating machines with precision gap or pressure control with heating and cooling capability, as well as preheating options with contact, infrared or hot air can be effectively used for fusion bonding.

The fusion bonding process may result in polymer sheet material at least partially melting and penetrating fabric substrate to the extent of 5 to 90% of thickness of fabric or 10% to 80% of thickness of the fabric or 20 to 70% of thickness of fabric. The hand or perceived softness of fabric substrate to touch as well as other physical properties including abrasion and water resistance may depend on the % thickness of fabric substrate penetrated by softened or melted polymer sheet material.

The fabric substrate or fused laminated fabric may be treated with various agents to impart beneficial properties. These agents may include but not limited to durable water repellents, softeners, UV protectors, flame retardants, stain and soil repellents, antimicrobials, mosquito repellents, odor mitigants and colorants or combinations thereof.

The fused laminated fabric may be recycled by any suitable recycling technique including mechanical or chemical recycling or a combination thereof. Mechanical recycling process may include, but not limited to, sorting, separation, washing, drying, tearing, cutting, shredding, grinding, granulation, melting, extrusion, pelletizing, compounding, blending and combinations thereof. Chemical recycling process may include, but not limited to, purification, dissolution, precipitation, de-coloration, depolymerization, hydrothermal treatment, enzymolysis, pyrolysis, gasification, and combinations thereof. Mechanical recycling may produce a fragmented material from the fused laminated fabric such as through shredding or cutting to make strips, granules, or pellets. The fragmented material may then be used in the fabrication of a textile article without separation of its components. In some embodiments, the waste from the cut and sew operations using the fused laminated fabric may be recycled to make new fibers as the components of the fused laminated fabric are made of the same base material or of compatible materials. For example, fabricating the textile article may include extruding the fragmented material and spinning the extruded fragmented material into a fiber.

In another example, the fragmented material may be recycled by using chemical recycling process, wherein the fragmented material can be broken down and recycled into new chemicals and polymerized to provide feed stream for extruding into new fibers. The fused laminated fabric enables more efficient chemical recycling as the components of the fused laminated fabric are made of the same base material or of compatible materials. In another example, the fragmented material may be recycled by using pyrolysis process, wherein the material is pyrolyzed under low oxygen conditions to provide building block molecules that can be polymerized to provide feed stream for extruding into new fibers or for other applications. The fused laminated fabric enables more efficient pyrolysis as the components of fused laminated fabric are made of the same base material or of compatible materials. The textile article may include a yarn, a sheet, a spun fabric, a fiber, a film, a resinous sheet, or an injection molded article. After consumer use when the fused laminated fabric becomes an end-of-life product, it may be recycled to produce a feed stock for fiber spinning or for making other useful articles, thereby, enabling circular economy.

Surface preparations on fabric as well as polymer sheets can enhance adhesion and help increase strength of bond between fabric layer and hot melt adhesive. Approaches include corona treatment of fabrics, a technique in which high voltage and high frequency are leveraged to create a corona discharge, to manipulate the inherent surface energy. This changes the inter-molecular bonds that occur when a surface bond is created. Another way to increase surface energy and reactivity is to treat the surface with atmospheric plasma, which is an ionized gas at atmospheric pressure, Submicron surface roughening of fabric using dielectric barrier discharge-based atmospheric low temperature plasma for improving bonding is another approach. Any process that can activate fabric surface or the polymer sheet surface or both surfaces to enhance adhesion may be used. Fabric surface preparation may also include scouring and drying to remove undesired processing aids that may remain on the fabric.

The recycled fused laminated fabric may be used to make an article of industrial utility. For example, the fused laminated fabric may be used to make articles such as nylon backpacks, water-resistant recyclable work wear, outdoor wear, safety wear, car covers, inflatable watercraft, inflatable mattresses, flexible storage tanks, oil booms, barriers for flood and soil protection, conveyer belts, umbrellas and tents.

Each of the non-limiting examples described herein can stand on its own or can be combined in various permutations or combinations with one or more of the other examples.

This overview is intended to provide an overview of subject matter of the present patent application. It is not intended to provide an exclusive or exhaustive explanation of the technology. The detailed description is included to provide further information about the present patent application.

### BRIEF DESCRIPTION OF THE DRAWINGS

FIG. 1 is a schematic representation of a lifecycle of an exemplary embodiment of a fused laminated fabric;

FIG. 2 illustrates a schematic depicting a cross section of an example of a fused laminated fabric; and

FIG. 3 illustrates a schematic depicting a close view of a cross section of another example of a fused laminated fabric.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

This document pertains generally, but not by way of limitation, to fused laminated fabrics for constructing various articles of consumer utility that are recyclable by conventional mechanical recycling processes such as cutting, shredding, and pelletizing. The fused laminated fabric may be reusable as a feedstock for creating new in-kind products, such as, films for packaging, fibers and fabrics, and injection molded articles.

Compatible materials may be used in the construction of the fused laminated fabric without using external adhesives such that the fused laminated fabric is external adhesive-free. External adhesives may be any adhesive made of a material that is made from a different material than the polymer sheet or fabric substrate. For example, if the fabric substrate and the polymer sheet are nylon based, a polyester-based adhesive would be an external adhesive and incompatible. Industrial textile external adhesives used for sealing or gluing fabric may include various spray or liquid adhesives, epoxies, and sealants.

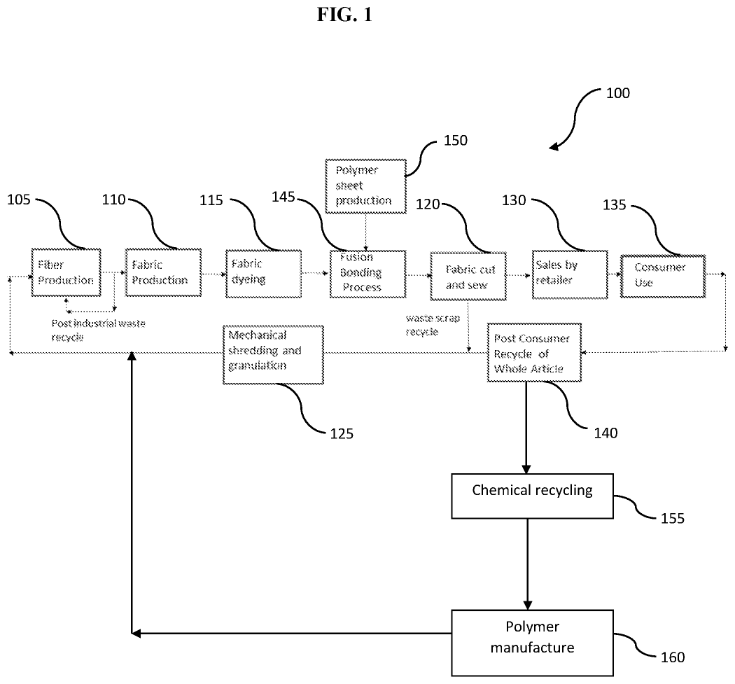

FIG. 1 is a schematic representation of a lifecycle 100 of an exemplary embodiment of a fused laminated fabric. The polymer sheet (150) and the fiber substrate (105) may first be produced. The fiber substrate may be woven to produce a fabric (110). Excess or waste fabric may be recycled back into the fiber substrate (105). The fabric produced may undergo any suitable finishing processes such as dyeing, conditioning, or softening (115). The fabric may be fused to the polymer sheet to produce a fused laminated fabric in a fusion bonding process (145). The fused laminated fabric may be cut or sewn as needed for the end-product article, such as a backpack (120). Any waste or excess fused laminated fabric may be re-fed into the recycling process, such as a mechanical shredding or granulating machine (125). The end-product article may go to a retailer (130) for sale to consumers (135). When the end-product is at its end of life, the whole end-product article may be recycled (140). The product can be recycled through a mechanical shredding or granulating machine to start a new life cycle (125). Alternatively, the product can be recycled in a chemical recycling process (155), such as a pyrolysis process. Polymers can be manufactured from the chemically recycled product to then start a new life cycle (160). This schematic representation shows waste recycling from several major process steps. However, it is possible to recycle waste that is generated in every process step.

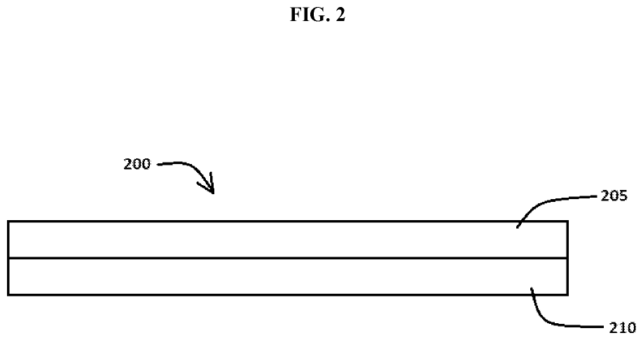

FIG. 2 illustrates schematic 200 depicting a cross section of an example of a fused laminated fabric according to various embodiments. Layer 205 can be viewed as representing a polymer sheet. Layer 210 can be viewed as representing a fabric substrate. The interface between layer 205 and layer 210 can represent a blending or fused joint when the polymer sheet embeds into the fabric substrate in the fusion bonding process.

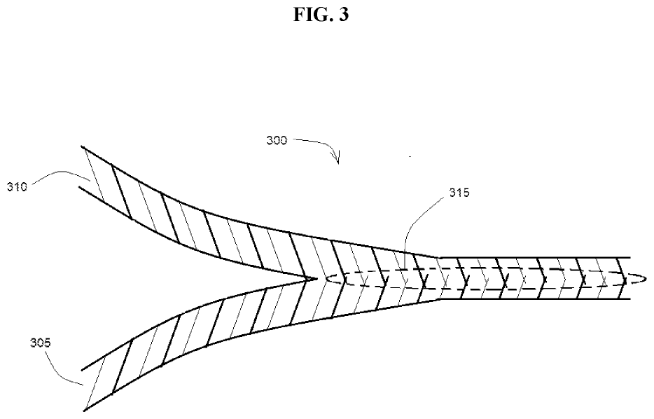

FIG. 3 illustrates schematic 300 depicting a close view of a cross section of an exemplary fused laminated fabric according to various embodiments. The fabric substrate 310 can be layered onto the polymer sheet 305. Upon subjecting the layered fabric substrate 310 and polymer sheet 305 to the fusion-bonding process, the polymer sheet 305 can be at least partially melted and can at least partially penetrate into the fabric substrate 310 at interface 315.

### EXAMPLES

Without limitation, various exemplary embodiments of fused laminated fabrics are provided below. Exemplary fabric substrates used in the examples include a 500 denier Coyote fabric made from 500 denier nylon-66 fiber, commercially available as INVISTA CORDURA® fiber. Exemplary hot melt adhesive polymers used in the examples include DS 002-2, 0.08 mm thick, from Shenzhen Tunsing Plastic Products Co., Ltd, Shenzhen City, Guangdong Province, China, N400 5-Mil 28″ Nylon hot melt adhesive film from Twill USA, TA-120 type polyamide hot melt adhesive film from Hengning, Hengsha Township, Chongming District, China, and polyester, polyolefin and polyurethane hot melt adhesive films also from these sources. Exemplary hot melt adhesive polymers also include thermoplastic polyurethane and aromatic polyester laminating films from SWM INTL and aliphatic thermoplastic polyurethane films and polyester thermo plastic polyurethane films are available from American Polyfilm.

Test Methods Used in Examples:
ASTM D3776 Fabric weight
ASTM D5034 Tensile Strength
ASTM D2261 Tear Strength
ASTM D2728 Bond Strength

AATCC TM 127-2017(1028)e: Water Resistance—Water Resistance may be measured by the water column test. This Hydrostatic Pressure Test measures the resistance of a fabric to the penetration of water under hydrostatic pressure. It is applicable to all types of fabrics, including those treated with a water resistant or water repellent finish. Water resistance depends on the repellency of the fibers and yarns, as well as the fabric construction. The results obtained by this method may not be the same as the results obtained by the AATCC methods for resistance to rain or water spray. Test results may have a range from 200 mm to 20,000 mm of water column depending on the type of fabric coating.

ASTM D3884 Taber abrasion (H18 wheel)—Taber abrasion test may be conducted with test method ASTM D3884 using H-18 wheel with a load of 500-gram weight. The number of rubs to failure was recorded. The failure determination is based on observation of breaks of both warp and weft yarns at the same location.

### Examples 1[A-B]: Fusion-Bonded Nylon Polymer Sheet on Nylon Fabric Substrate

This example demonstrates a fusion-bonded nylon polymer sheet onto a nylon fabric substrate.

These examples use a 500 denier Coyote fabric made from 500 denier nylon-66 fiber, commercially available as INVISTA CORDURA® fiber. The size of the fabric may be about 0.15 m×0.15 m [6″×6″] square piece. The 0.08 mm thickness hot-melt Nylon adhesive film [DS 002-2], used for bonding to the nylon fabric substrate, has a release paper. Hot iron may be used to fusion bond this layer of hot-melt Nylon adhesive film at 170-180° C. from the release paper side and moving the iron on the release paper surface side for a total of 60 seconds. Visual inspection may show penetration of the hot-melt Nylon adhesive film into the fabric substrate. Separation of the hot-melt Nylon adhesive film by peeling of the layer by hand is not possible, thereby indicating good fusion bonding to the nylon fabric substrate.

The fusion-bonded nylon fused laminated fabric specimen weight may be measured to be 199.5 gm/m² and according to ASTM D3776 method. Taber abrasion test method ASTM 3884 with H18 wheel may be used to measure abrasion resistance of the specimen from fabric side. The test can be performed on both fused laminated fabric specimen [Example 1A] and un-laminated control fabric specimen [Example 1B]. The test may be conducted with 500-gram weight and the number of rubs to failure is recorded. The failure determination is based on observation of breaks of both warp and weft yarns at the same location. A duplicate for each specimen may be conducted and the average number of rubs to failure is recorded, as shown in the example of Table 2 below.

Unless specifically stated, Nylons referred to in this table may be Nylon 66, Nylon 6. polyamides, their copolymers or blends thereof. Polyesters referred to in this table will include their copolymers or blends thereof. Polypropylenes referred to in this table will include their copolymers or blends thereof.

TABLE 2

| | | Average Number of Rubs |
|---|---|---|
| | | to Failure [Taber |
| Ex. | | abrasion test method ASTM |
| ID | Specimen Description | 3884 with H18 wheel] |
| 1A | 500 denier INVISTA | 2550 |
| | CORDURA ® Coyote fabric - with | |
| | laminating film | |
| 1B | 500 denier INVISTA | 375 |
| | CORDURA ® Coyote fabric - | |
| | Control [no laminating film] | |
| 12 | Polyester fabric with 0.1 mm | >10000 |
| | copolyester film | |
| 13 | Polyester fabric with 0.05 mm | >10000 |
| | polyester-based TPE film | |
| 14 | Polyester control fabric - no | 700 |
| | lamination | |
| 15 | Polypropylene fabric with 0.05 mm | 3050 |
| | LDPE film | |
| 16 | Polypropylene fabric with 0.1 mm | 3200 |
| | LDPE film | |
| 17 | Polypropylene fabric with 0.1 mm | 6950 |
| | polypropylene film | |
| 18 | Polypropylene fabric with 0.1 mm | 2800 |
| | HDPE film | |
| 19 | Polypropylene fabric with 0.05 mm | 1700 |
| | EVA film | |
| 20 | Polypropylene control fabric - no | 700 |
| | lamination | |
| 21 | Nylon 6 fabric with 0.05 mm co- | 4500 |
| | polyamide film | |
| 22 | Nylon 6 fabric with 0.1 mm co- | >10000 |
| | polyamide film | |
| 23 | Nylon 6 control fabric - no | 400 |
| | lamination | |

Table 2 data shows that the average number of rubs to failure increases from 375 for control specimen [Example 1B] to 2550 for fully fusion-bonded fused laminated fabric [Example 1A], an almost 7×improvement. Such level of improvement is surprising and unexpected. It may also be observed that the other side of the fused laminated fabric [i.e., release paper side] may be smooth and usable without a liner film thereby potentially saving costs.

In these illustrative examples, a hot iron may be used to hot press or laminate the hot-melt Nylon adhesive film onto the fabric face. Commercially available laminating processes may be used on a larger scale to accomplish a full fusion bonding. For example, commercial laminating machines with precision gap or pressure control with heating and cooling capability, as well as preheating options with contact, infrared or hot air or other means can be effectively used. Calendaring machines with multiple rollers can be used for widths from 600 mm to 1600 mm and from 1850 mm to 6000 mm and reaching line speeds of up to 100 meters per minute,

### Example 2: Article Made from Nylon Fabric with Fully Fusion-Bonded Fused Laminated Fabric

A large section of the nylon fabric with fully fusion-bonded fused laminated fabric, prepared according to Example 1A, may be cut to proper dimensions and sewn into a backpack article having the linear dimensions of 70 cm length×50 cm height×25 cm wide. The backpack article may weigh approximately 1400 grams. The nylon thread may be used for stitching the six sides in forming the backpack article. The other accessories, for example, straps, buckles, belts, buttons, zippers, may be made from the same nylon material.

The excess or scrap fused laminated fabric pieces resulting from the cut and sew steps may be collected and mechanically size-reduced to small fragments, for example, 1×1 mm or 2×1 mm size. These fragments may be taken back to the nylon polymerization process. These feed materials can also be converted to pulverized pellets so they can be blended with virgin polymer pellets, dried and fed into extruders for spinning fiber. Hence, Example 1A nylon fabric with full fusion-bonded fused laminated fabric does not need separation and sorting and enables easier recycling.

This approach applies to fabrics made from Nylon 66, Nylon 6, other nylon types, or copolymers or blends thereof.

Example 2 demonstrates the industrial utility of the fused laminated fabric in terms of minimizing the raw material waste and recycle back to the process. The recyclability/reusability along with waste minimization may be achieved in this approach.

The article, prepared according to Example 2, was subjected to wear-n-tear testing and water resistance testing. The fused laminated fabric provided satisfactory rigidity, robustness and water resistance. The results were consistent with the Table 1 results for Ex. 1A compared to Ex. 1B.

The article, prepared according to Example 2, and the circularity it offers may provide improved Life Cycle Analysis (LCA) metrics in terms of resource reduction, energy use reduction and the reduction in overall Global Warming Potential.

### Example 3

A backpack article, in similar dimensions to that in Example 2, may be prepared except the control fabric of Example 1B may be used. The article does not display good wear-n-tear performance. As noted in Example 1B, abrasion resistance may be poor. Also, the water resistance of this fabric may be low because of the porous nature of the fabric.

### Example 4: Articles Made from Combined Nylon Fabric and Polyurethane Coating

The example 3 article may be repeated except the nylon fabric substrate of Example 1B may be coated with a polyurethane liquid coating (solvent based or water based) and cured to provide water resistance. The article may be sewn from this lined nylon fabric substrate. The article may show good performance that may be comparable to the Example 2 article. However, the excess or scrap fabric pieces from the cut and sew steps contain incompatible materials. These pieces may be not suitable for recycle back in the process. Attempts to separate out the nylon from polyurethane materials at the end of life of the article may become cumbersome and cost-prohibitive with low yields. Using such recycled materials for extrusion and spinning may result in low yields. These scrap pieces remain unusable and may end up in a landfill.

### Example 5: Articles Made from Combined Nylon Fabric Substrate and a Thermoplastic Urethane (TPU) Lining

The example 3 article may be repeated except the nylon fabric substrate of Example 1B may be laminated with a thermoplastic urethane liner to provide water resistance. The article may be sewn from this lined nylon material. The article may show good performance that may be comparable to the Example 2 article. However, the excess or scrap fabric pieces resulting from the cut and sew steps contained incompatible materials. These pieces may not be suitable for recycle back in the process. Attempts to separate out the nylon from thermoplastic urethane materials at the end of life of the article may become cumbersome and cost-prohibitive with low yields. Using such recycled materials for extrusion and spinning may result in low yields. These scrap pieces remain unusable and may end up in landfill.

### Example 6: Articles Made from Combined Nylon Fabric Substrate and Thermoplastic Elastomer (TPE) Lining

The Example 3 article may be repeated except the nylon fabric of Example 1B may be laminated with a thermoplastic elastomer liner to provide water resistance. The article may be sewn from this lined nylon material. The article may show good performance that may be comparable to the Example 2 article. However, the excess or scrap fabric pieces resulting from the cut and sew steps contain incompatible materials. These pieces are not suitable for recycle back in the process. Attempts to separate out the nylon from thermoplastic elastomer materials at the end of life of the article may become cumbersome and cost-prohibitive with low yields. Using such recycled materials for extrusion and spinning may result in low yields. These scrap pieces remain unusable and may end up in landfill.

### Example 7: Articles Made from Combined Polyester Fabric and Polyurethane Coating

The Example 3 article may be repeated except the nylon fabric of Example 1B was replaced by polyester fabric and coated with a polyurethane liquid coating (solvent based or water based) and cured to provide water resistance. The article may be sewn from this lined polyester material. The article may show good performance that may be comparable to the Example 2 article. However, the excess or scrap fabric pieces resulting from the cut and sew steps contain incompatible materials. These pieces may not be suitable for recycle back in the process. Attempts to separate out the polyester from polyurethane materials at the end of life of the article may become cumbersome and cost-prohibitive with low yields. Using such recycled materials for extrusion and spinning may result in low yields. These scrap pieces remain unusable and may end up in a landfill.

### Example 8: Articles Made from Combined Polyester Fabric and Thermoplastic Elastomer (Tpe) Lining

The Example 3 article may be repeated except the nylon fabric of Example 1B may be replaced by polyester fabric and laminated with a thermoplastic elastomer liner to provide water resistance. The article may be sewn from this lined polyester material. The article may show good performance that may be comparable to the Example 2 article. However, the excess or scrap fabric pieces resulting from the cut and sew steps may contain incompatible materials. These pieces may not be suitable for recycle back in the process. Attempts to separate out the polyester from thermoplastic elastomer materials at the end of life of the article may become cumbersome and cost-prohibitive with low yields. Using such recycled materials for extrusion and spinning may result in low yields. These scrap pieces remain unusable and may end up in a landfill. However, if the thermoplastic elastomer material is derived from polyester, then it could be compatible with polyester fabric for recycling.

### Example 9: Articles Made from Combined Polyester Fabric with Fully Fusion Bonded Polyester Film

The Example 3 article may be repeated except the nylon fabric of Example 1B may be replaced by polyester fabric and fully fusion bonded with a hot melt adhesive polyester film to provide water resistance. The article may be sewn from this lined polyester material. The article may show good performance in water resistance.

The excess or scrap fabric pieces resulting from the cut and sew steps may be collected and mechanically size-reduced to small fragments, for example, 1×1 mm or 2×1 mm size. These small fragments may be taken back to the nylon polymerization process. These feed materials can also be converted to pulverized pellets so they can be blended with virgin polymer pellets, dried and fed into extruders for spinning fiber. Hence, polyester fabric with full fusion bonding of polyester film does not need separation and sorting and enables easier recycling. This approach applies to fabrics made from virgin polyester or recycled polyester from used bottles, or polyester copolymers or blends thereof. A non-limiting example of recycled polyester is recycled polyethylene terephthalate or rPET pellets available from Indorama Ventures Sustainable Recycling (IVSR).

This example demonstrates the industrial utility of the polyester fabric in terms of minimizing the raw material waste and recycle back to the process. The recyclability/reusability along with waste minimization may be achieved in this approach. The article, prepared according to Example 9, and the circularity it offers may result in improved Life Cycle Analysis (LCA) metrics in terms of resource reduction, energy use reduction and the reduction in overall Global Warming Potential.

### Example 10: Article Made from Nylon Fabric with Polyester Liner

A large section of the Example 1B nylon fabric may be partially bonded to polyester liner. The resulting lined nylon fabric may be cut to proper dimensions and sewn into a waterproof raincoat having the linear dimensions of 90 cm length×80 cm wide. This raincoat article may be made of nylon outer shell and with a polyester liner. For example, it may weigh approximately 600 grams. However, the excess or scrap fabric pieces resulting from the cut and sew steps contain incompatible materials. These pieces may not be suitable for recycle back in the process. Attempts to separate out the nylon from polyester liner materials at the end of life of the article may become cumbersome and cost-prohibitive with low yields. Using such recycled materials for extrusion and spinning may result in low yields. These scrap pieces remain unusable and may end up in a landfill.

### Example 11: Article Made from Nylon Fabric with Fully Fusion-Bonded Nylon Film

A large section of the nylon fabric with fully fusion-bonded nylon hot melt adhesive film, prepared according to Example 1A, may be cut to proper dimensions and sewn into a raincoat article having the linear dimensions of 90 cm length×80 cm wide. The raincoat article may weigh approximately 600 grams. The other accessories, for example, buckles, belts, buttons, zippers, may be made from the same nylon material.

The excess or scrap fabric pieces resulting from the cut and sew steps may be collected and mechanically size-reduced to small fragments, for example, 1×1 mm or 2×1 mm size. These small fragments may be taken back to the nylon polymerization process. These feed materials can also be converted to pulverized pellets so they can be blended with virgin polymer pellets, dried and fed into extruders for spinning fiber. Hence, nylon fabric with full fusion bonding of nylon film does not need separation and sorting and enables easier recycling. This approach applies to fabrics made from Nylon 66 or Nylon 6 or copolymers or blends thereof.

This example demonstrates the industrial utility of the nylon fabric in terms of minimizing the raw material waste and recycle back to the process. The recyclability/reusability along with waste minimization may be achieved in this approach. The article, prepared according to Example 11, provided satisfactory rigidity, robustness and water resistance performance. The results may be consistent with the Table 1 results for Ex. 1A compared to Ex. 1B. The article, prepared according to Example 11, and the circularity it offers may result in improved Life Cycle Analysis (LCA) metrics in terms of resource reduction, energy use reduction and the reduction in overall Global Warming Potential.

### Example 12: Fusion-Bonded Co-Polyester Polymer Film on Polyester Fabric Substrate

This example demonstrates a fusion-bonded co-polyester polymer film onto polyester fabric substrate. This example uses a commercially available medium weight polyester woven fabric of about 220 gm/m², as may be measured according to ASTM D3776 method. The copolyester film, TUNSING DS001TS, of 0.1 mm thickness is used for bonding to the polyester fabric substrate. Both fabric and film substrate can be cut to 15″×15″ square pieces for lamination. Bonding may be done on a Carver heat press at 125° C. temperature, 0.6 MPa pressure and 15 seconds duration. A teflon film may be used between the platen and the fabric or the film to prevent sticking with the platen.

Taber abrasion test method ASTM 3884 with H18 wheel may be used to measure abrasion resistance of the specimen from fabric side. The test may be conducted with 500-gram weight and the number of rubs to failure is recorded. The failure determination is based on observation of breaks of both warp and weft yarns at the same location. A duplicate for each specimen may be conducted and the average number of rubs to failure is recorded. Taber abrasion resistance is significantly improved over a non-laminated fabric (Example 14), as shown in Table 2. The laminated fabric of this Example provided satisfactory rigidity, tear strength, and water resistance.

The polyester fabric with fully fusion-bonded lamination fabric, prepared according to this Example, may be cut to proper dimensions and sewn into a backpack article. The other components and accessories, for example, straps, buckles, belts, buttons, zippers and sewing thread may be made from similar type of polyester or copolyester material, as much as possible. The fabric of this Example may also be used to prepare other articles that require superior water resistance and abrasion resistance.

### Example 13: Fusion-Bonded Polyester-Based TPE Polymer Film on Polyester Fabric Substrate

This example demonstrates a fusion-bonded polyester-based TPE polymer film onto polyester fabric substrate. This example is similar to Example 12 except that the polymer film is polyster-based TPE film, BOSTIK TC 420, of 0.05 mm thickness. Carver Press temperature may be 130° gm/m2 and the polymer film is TPE film of 0.05 mm thickness. Carver Press temperature may be 132° C. Taber abrasion resistance is significantly improved over a non-laminated fabric (Example 14), as shown in Table 2. The laminated fabric of this Example provided satisfactory rigidity, tear strength, and water resistance.

The polyester fabric with fully fusion-bonded lamination fabric, prepared according to this Example, may be cut to proper dimensions and sewn into a backpack article. The other components and accessories, for example, straps, buckles, belts, buttons, zippers and sewing thread may be made from similar type of polyolefin material, as much as possible. The fabric of this Example may also be used to prepare other articles that require superior water resistance and abrasion resistance.

### Example 14: Control Polyester Fabric with No Lamination

This example represents polyester fabric used in Examples 12 and 13 with no lamination.

### Example 15: Fusion-Bonded LDPE Polymer Film on Polypropylene Fabric Substrate

This example demonstrates a fusion-bonded LDPE polymer film onto polypropylene fabric substrate. This example is similar to Example 12 except that the fabric substrate is polypropylene fabric of about 270 gm/m2 and the polymer film is LDPE film of 0.05 mm thickness. Carver Press temperature may be 132° C. Taber abrasion resistance is significantly improved over a non-laminated fabric (Example 20), as shown in Table 2. The laminated fabric of this Example provided satisfactory rigidity, tear strength and water resistance.

The polypropylene fabric with fully fusion-bonded lamination fabric, prepared according to this Example, may be cut to proper dimensions and sewn into a backpack article. The other components and accessories, for example, straps, buckles, belts, buttons, zippers and sewing thread may be made from similar type of polyolefin material, as much as possible. The fabric of this Example may also be used to prepare other articles that require superior water resistance and abrasion resistance.

### Example 16: Fusion-Bonded LDPE Polymer Film on Polypropylene Fabric Substrate

This example demonstrates a fusion-bonded LDPE polymer film onto polypropylene fabric substrate. This example is similar to Example 15 except that the polymer film is LDPE film of 0.1 mm thickness. Carver Press temperature may be 120° C. Taber abrasion resistance is significantly improved over a non-laminated fabric (Example 20), as shown in Table 2. The laminated fabric of this Example provided satisfactory rigidity, tear strength, and water resistance.

### Example 17: Fusion-Bonded Polypropylene Film on Polypropylene Fabric Substrate

This example demonstrates a fusion-bonded polypropylene polymer film onto polypropylene fabric substrate. This example is similar to Example 15 except that the polymer film is polypropylene film, TUNSING DS617, of 0.1 mm thickness. Carver Press temperature may be 125° C. Taber abrasion resistance is significantly improved over a non-laminated fabric (Example 20), as shown in Table 2. The laminated fabric of this Example provided satisfactory rigidity, tear strength, and water resistance.

### Example 18: Fusion-Bonded HDPE Film on Polypropylene Fabric Substrate

This example demonstrates a fusion-bonded HDPE polymer film onto polypropylene fabric substrate. This example is similar to Example 15 except that the polymer film is HDPE film of 0.1 mm thickness. Carver Press temperature may be 145° C. Taber abrasion resistance is significantly improved over a non-laminated fabric (Example 20), as shown in Table 2. The laminated fabric of this Example provided satisfactory rigidity, tear strength, and water resistance.

### Example 19: Fusion-Bonded EVA (Ethylene Vinyl Acetate) Film on Polypropylene Fabric Substrate

This example demonstrates a fusion-bonded EVA polymer film onto polypropylene fabric substrate. This example is similar to Example 15 except that the polymer film is EVA film of 0.05 mm thickness. Carver Press temperature may be 90° C. Taber abrasion resistance is significantly improved over a non-laminated fabric (Example 20), as shown in Table 2. The laminated fabric of this Example provided satisfactory rigidity, tear strength, and water resistance.

### Example 20: Control Polypropylene Fabric with No Lamination

This example represents polypropylene fabric used in Examples 16 through 20 with no lamination.

### Example 21: Fusion-Bonded Co-Polyamide Polymer Film on Nylon 6 Fabric Substrate

This example demonstrates a fusion-bonded co-polyamide polymer film onto nylon6 fabric substrate. This example is similar to Example 12 except that the fabric substrate is nylon 6 fabric of about 190 gm/m2 and the polymer film is co-polyamide film, TUNSING DS002, of 0.05 mm thickness. Carver Press temperature may be 125° C. Taber abrasion resistance is significantly improved over a non-laminated fabric (Example 23), as shown in Table 2. The laminated fabric of this Example provided satisfactory rigidity, tear strength, and water resistance.

The nylon 6 fabric with fully fusion-bonded lamination fabric, prepared according to this Example, may be cut to proper dimensions and sewn into a backpack article. The other components and accessories, for example, straps, buckles, belts, buttons, zippers and sewing thread may be made from similar type of polyamide or co-polyamide material, as much as possible. The fabric of this Example may also be used to prepare other articles that require superior water resistance and abrasion resistance.

### Example 22: Fusion-Bonded Co-Polyamide Polymer Film on Nylon 6 Fabric Substrate

This example demonstrates a fusion-bonded co-polyamide polymer film onto nylon6 fabric substrate. This example is similar to Example 21 except that the polymer film is co-polyamide film, TUNSING DS002-2, of 0.1 mm thickness. Carver Press temperature may be 130° C. Taber abrasion resistance is significantly improved over a non-laminated fabric (Example 23), as shown in Table 2. The laminated fabric of this Example provided satisfactory rigidity, tear strength, and water resistance.

### Example 23: Control Nylon 6 Fabric with No Lamination

This example represents nylon 6 fabric used in Examples 21 and 22 with no lamination.

### Example 24: End-of-Life Article and Recyclability

The illustrative articles, described in Examples 2 through 23, were evaluated for their recyclability and circularity attributes. Table 3 below provides a summary of these results.

Unless specifically stated, Nylons referred to in this table may be Nylon 66, Nylon 6, polyamides, their copolymers or blends thereof. Polyesters referred to in this table will include their copolymers or blends thereof. Polypropylenes referred to in this table will include their copolymers or blends thereof.

TABLE 3

| | | | | | Cut-n- | | Recycl- |
|---|---|---|---|---|---|---|---|
| | | | Coating or | Other | sew | End-of- | ability/ |
| Article | Construction | Fabric | laminating | acces- | excess | Life | circularity |
| of | Materials | Substrate | material | sories | material | material | achieved? |
| Example | Nylon fabric | nylon | nylon | nylon | 100% | 100% | Yes |
| 2 | laminated | | | | recyclable | recyclable | |
| | with nylon | | | | | | |
| | film | | | | | | |
| Example | Unlaminated | nylon | — | nylon | 100% | N/A [article does not | |
| 3 | nylon fabric | | | | recyclable | meet desired | |
| | | | | | | performance] | |
| Example | Nylon fabric | nylon | PU coating | nylon | Not | Not | No |
| 4 | with | | | | recyclable | recyclable | |
| | polyurethane | | | | | unless | |
| | liquid coating | | | | | significant | |
| | | | | | | effort/cost | |
| | | | | | | to | |
| | | | | | | separate/ | |
| | | | | | | sort/ | |
| | | | | | | decon- | |
| | | | | | | taminate | |
| Example | Nylon fabric | nylon | Thermos- | nylon | Not | Not | No |
| 5 | with | | plastic | | recyclable | recyclable | |
| | thermoplastic | | polyur- | | | unless | |
| | polyurethane | | ethane (TPU) | | | significant | |
| | laminate | | liner | | | effort/cost | |
| | | | | | | to | |
| | | | | | | separate/ | |
| | | | | | | sort/ | |
| | | | | | | decon- | |
| | | | | | | taminate | |
| Example | Nylon fabric | nylon | Thermo- | nylon | Not | Not | No |
| 6 | with | | plastic | | recyclable | recyclable | |
| | thermoplastic | | elastomer | | | unless | |
| | elastomer | | (TPE) liner | | | significant | |
| | laminate | | | | | effort/cost | |
| | | | | | | to | |
| | | | | | | separate/ | |
| | | | | | | sort/ | |
| | | | | | | decon- | |
| | | | | | | taminate | |
| Example | Polyester | Polyester | PU coating | Poly- | Not | Not | No |
| 7 | fabric with | | | ester | recyclable | recyclable | |
| | polyurethane | | | | | unless | |
| | liquid coating | | | | | significant | |
| | | | | | | effort/cost | |
| | | | | | | to | |
| | | | | | | separate/ | |
| | | | | | | sort/ | |
| | | | | | | decon- | |
| | | | | | | taminate | |
| Example | Polyester | Polyester | Incompatible | Poly- | Not | Not | No |
| 8 | fabric with | | Thermo- | ester | recyclable | recyclable | |
| | thermoplastic | | plastic | | | unless | |
| | elastomer | | elastomer | | | significant | |
| | laminate | | (TPE) liner | | | effort/cost | |
| | | | | | | to | |
| | | | | | | separate/ | |
| | | | | | | sort/ | |
| | | | | | | decon- | |
| | | | | | | taminate | |
| Example | Polyester | Polyester | Polyester | Poly- | 100% | 100% | Yes |
| 9 | fabric | | | ester | recyclable | recyclable | |
| | laminated | | | | | | |
| | with polyester | | | | | | |
| | film | | | | | | |
| Example | Nylon fabric | nylon | Polyester | nylon | Not | Not | No |
| 10 | with polyester | | Liner | | recyclable | recyclable | |
| | Liner | | | | | unless | |
| | | | | | | significant | |
| | | | | | | effort/ | |
| | | | | | | cost to | |
| | | | | | | separate/ | |
| | | | | | | sort/ | |
| | | | | | | decon- | |
| | | | | | | taminate | |
| Example | Nylon fabric | nylon | nylon | nylon | 100% | 100% | Yes |
| 11 | laminated | | | | recyclable | recyclable | |
| | with nylon | | | | | | |
| | film | | | | | | |
| Example | Polyester | Polyester | Copoly- | Poly- | 100% | 100% | Yes |
| 12 | fabric | | ester | ester or | recyclable | recyclable | |
| | laminated | | | copoly- | | | |
| | with | | | ester | | | |
| | copolyester | | | | | | |
| | film | | | | | | |
| Example | Polyester | Polyester | Polyester- | Poly- | 100% | 100% | Yes |
| 13 | fabric | | based TPE | ester or | recyclable | recyclable | |
| | laminated | | | copoly- | | | |
| | with | | | ester | | | |
| | polyester- | | | | | | |
| | based TPE | | | | | | |
| | film | | | | | | |
| Example | Unlaminated | Polyester | — | Poly- | 100% | N/A | |
| 14 | polyester | | | ester | recyclable | (article | |
| | fabric | | | | | does not | |
| | | | | | | meet | |
| | | | | | | desired | |
| | | | | | | perfor- | |
| | | | | | | mance) | |
| Example | Polypro- | Polypro- | LDPE | Poly- | 100% | 100% | Yes |
| 15 | pylene fabric | pylene | | olefin | recyclable | recyclable | |
| | laminated | | | | | | |
| | with LDPE | | | | | | |
| | film | | | | | | |
| Example | Polypro- | Polypro- | LDPE | Poly- | 100% | 100% | Yes |
| 16 | pylene fabric | pylene | | olefin | recyclable | recyclable | |
| | laminated | | | | | | |
| | with LDPE | | | | | | |
| | film | | | | | | |
| Example | Polypro- | Polypro- | Polypro- | Poly- | 100% | 100% | Yes |
| 17 | pylene fabric | pylene | pylene | olefin | recyclable | recyclable | |
| | laminated | | | | | | |
| | with polypro- | | | | | | |
| | pylene film | | | | | | |
| Example | Polypro- | Polypro- | HDPE | Poly- | 100% | 100% | Yes |
| 18 | pylene fabric | pylene | | olefin | recyclable | recyclable | |
| | laminated | | | | | | |
| | with HDPE | | | | | | |
| | film | | | | | | |
| Example | Polypro- | Polypro- | EVA | Poly- | 100% | 100% | Yes |
| 19 | pylene fabric | pylene | | olefin | recyclable | recyclable | |
| | laminated | | | | | | |
| | with EVA | | | | | | |
| | film | | | | | | |
| Example | Unlaminated | Polypro- | N/A | Polypro- | 100% | N/A | |
| 20 | polypro- | pylene | | pylene | recyclable | (article | |
| | pylene fabric | | | | | does not | |
| | | | | | | meet | |
| | | | | | | desired | |
| | | | | | | perfor- | |
| | | | | | | mance) | |
| Example | Nylon 6 | Nylon 6 | Co- | Poly- | 100% | 100% | Yes |
| 21 | fabric | | polyamide | amide | recyclable | recyclable | |
| | laminated | | | or co- | | | |
| | with co- | | | poly- | | | |
| | polyamide | | | amide | | | |
| | film | | | | | | |
| Example | Nylon 6 | Nylon 6 | Co- | Poly- | 100% | 100% | Yes |
| 22 | fabric | | polyamide | amide | recyclable | recyclable | |
| | laminated | | | or co- | | | |
| | with co- | | | poly- | | | |
| | polyamide | | | amide | | | |
| | film | | | | | | |
| Example | Unlaminated | Nylon 6 | N/A | Poly- | 100% | N/A | |
| 23 | nylon 6 fabric | | | amide | recyclable | (article | |
| | | | | | | does not | |
| | | | | | | meet | |
| | | | | | | desired | |
| | | | | | | perfor- | |
| | | | | | | mance) | |

Articles made from the laminated fabrics described herein may be recycled by a mechanical recycling process, a chemical recycling process or combination thereof, depending on the requirements of the applications in which recycled materials may be used. Mechanical recycling process may include, but not limited to, sorting, separation, washing, drying, tearing, cutting, shredding, grinding, granulation, melting, extrusion, pelletizing, compounding, blending and combinations thereof. Chemical recycling process may include, but not limited to, purification, dissolution, precipitation, de-coloration, depolymerization, hydrothermal treatment, enzymolysis, pyrolysis, gasification, and combinations thereof. The outputs from the recycling process may range from simple molecular building blocks to polymers to fibers to fabrics to composite structures. Articles made from the laminated fabrics disclosed herein may be easier to be recycled into polymers and/or molecular building blocks of higher value than the other coated fabrics. Choice of a specific recycling process may also depend on the polymer type being recycled.

The above description includes references to the accompanying drawing, which form a part of the detailed description. The drawings show, by way of illustration, specific embodiments in which the fused laminated fabric be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the fused laminated fabric should be determined with reference to the appended claims, along with the full scope of equivalents to which such claims are entitled.

Statements:

1. A composition comprising:
a fabric substrate having a first melting temperature; and
a polymer sheet having a second melting temperature, wherein the second melting temperature is less than the first melting temperature;
wherein the polymer sheet and the fabric substrate are fused by a fusion-bonding process to form a fused laminated fabric;
wherein the fusion-bonding process applies heat and pressure sufficient to at least partially melt the polymer sheet at an interface of the polymer sheet and the fabric substrate such that the polymer sheet penetrates at least partially into the fabric substrate.

2. The composition of statement 1, wherein the polymer sheet includes a hot melt adhesive polymer, a film, web, a resinous sheet, or a combination thereof, and wherein the minimum melt temperature is approximately 60° C.

3. The composition of statement 2, wherein:
the polymer sheet includes a polyamide, a copolyamide or a blend thereof, and the fabric substrate includes a Nylon 66 polymer, a Nylon 66 co-polymer, a Nylon 6 polymer, a Nylon 6 co-polymer, a Nylon 10 polymer, a Nylon 10 co-polymer, a Nylon 12 polymer, a Nylon 12 co-polymer, a Nylon 11 polymer, or a Nylon 11 co-polymer, or a blend thereof; or
the polymer sheet includes a polyester, a polyester copolymer or a blend thereof, and the fabric substrate includes a polyester or a polyester copolymer or a blend thereof; or
the polymer sheet includes a polyolefin, a polyolefin copolymer or a blend thereof, and the fabric substrate includes a polyolefin or a polyolefin copolymer or a blend thereof.

4. The composition of statement 1, wherein the fabric substrate comprises:
a membrane, non-woven fabric, plain-woven fabric, knitted fabric, fibrous sheet, blended yarn fabric, three-dimensional fabric, embossed fabric, a film, or a resinous sheet;
an activated or modified surface for improved adhesion created by corona treatment, atmospheric plasma, or dielectric barrier discharge-based atmospheric low temperature plasma; or
a combination thereof.

5. The composition of statement 1, wherein the fabric substrate and the polymer sheet have a base thermoplastic polymer in common, wherein the thermoplastic polymer includes polyethylene terephthalate, polypropylene, polyethylene, or thermoplastic polyamide.

6. The composition of statement 1, wherein the fabric substrate and the polymer sheet have a base thermoplastic polymer in common, wherein the thermoplastic polymer includes thermoplastic polyurethane.

7. The composition of statement 1, wherein the fused laminated fabric is free of external adhesive.

8. The composition of statement 1, wherein the fused laminated fabric is water resistant and wherein a water resistance performance of the fused laminated fabric ranges from approximately 50 mm to approximately 20,000 mm of water by AATCC TM 127-2017(1028)e Water Resistance test method.

9. The composition of statement 1, wherein the fusion-bonding process results in at least partially melting the polymer sheet and penetration of the polymer sheet into the fabric substrate by about 5% to about 90% of thickness of fabric substrate.

10. The composition of statement 1, wherein a thickness of the polymer sheet is approximately 0.1 mil to approximately 20 mil or approximately 0.5 mil to approximately 10 mil, the polymer sheet is approximately 1% to approximately 40% of a total weight of the fused laminated fabric, or a combination thereof.

11. The composition of statement 1, wherein a difference between the first melting temperature and the second melting temperature is approximately 10° C. to approximately 200° C.

12. The composition of statement 1, wherein the fabric substrate or the polymer sheet or both have an activated or modified surface for improved adhesion created by corona treatment, atmospheric plasma, or dielectric barrier discharge-based atmospheric low temperature plasma.

13. A method of making a fused laminated fabric, comprising:
at least partially melting a polymer sheet;
laminating the at least partially melted polymer sheet and a fabric substrate, the fabric substrate having a first melting temperature and the polymer sheet having a second melting temperature, wherein the second melting temperature is less than the first melting temperature; and
fusing the laminated polymer sheet and the fabric substrate by a fusion-bonding process to form the fused laminated fabric,
wherein the fusion-bonding process includes processing at a temperature less than the first melting temperature.

14. The method of statement 13, wherein
the fabric substrate comprises a membrane, non-woven fabric, plain-woven fabric, knitted fabric, fibrous sheet, blended yam fabric, three-dimensional fabric, embossed fabric, a film, or a resinous sheet, or a combination thereof
the polymer sheet includes a hot melt adhesive polymer, a film, web, a resinous sheet, or a combination thereof;
the fabric substrate and the polymer sheet have a base thermoplastic polymer in common; or
a combination thereof.

15. The method of statement 13, wherein:
the polymer sheet includes a polyamide, a copolyamide or a blend thereof, and the fabric substrate includes a Nylon 66 polymer, a Nylon 66 co-polymer, a Nylon 6 polymer, a Nylon 6 co-polymer, a Nylon 10 polymer, a Nylon 10 co-polymer, a Nylon 12 polymer, a Nylon 12 co-polymer, a Nylon 11 polymer, or a Nylon 11 co-polymer, or a blend thereof; or
the polymer sheet includes a polyester, a polyester copolymer or a blend thereof, and the fabric substrate includes a polyester or a polyester copolymer or a blend thereof or
the polymer sheet includes a polyolefin, a polyolefin copolymer or a blend thereof, and the fabric substrate includes a polyolefin or a polyolefin copolymer or a blend thereof.

16. The method of statement 13, wherein the fused laminated fabric is water resistant, wherein a water resistance performance of the fused laminated fabric ranges from approximately 50 mm to approximately 20,000 mm of water by AATCC TM 127-2017(1028)e Water Resistance test method.

17. The method of statement 13, wherein the thickness of the polymer sheet is approximately 0.1 mil to approximately 20 mil, the polymer sheet is approximately 1% to approximately 40% of the total weight of the fused laminated fabric, or a combination thereof.

18. The method of statement 13, wherein the fusion-bonding process results in at least partially melting the polymer sheet and penetration of the polymer sheet into the fabric substrate by about 5% to about 90% of thickness of fabric substrate.

19. A method of making a textile article, comprising:
receiving a fragmented material, wherein the fragmented material includes a fused lamination of a fabric substrate having a first melting temperature and a polymer sheet having a second melting temperature, wherein the second melting temperature is less than the first melting temperature; and
fabricating the textile article, wherein the textile article includes the fragmented material.

20. The method of statement 19, wherein:
the fragmented material is in the form of strips, granules, or pellets;
the textile article includes a yarn, a sheet, a spun fabric, a fiber, a film, a resinous sheet, or an injection molded article; or
a combination thereof.

21. The method of statement 19, wherein the textile article includes mechanically recycled fragmented material or chemically recycled fragmented material, wherein the chemically recycled fragmented material optionally includes a pyrolyzed fragmented material.

The specific methods, devices and compositions described herein are representative of preferred embodiments and are exemplary and not intended as limitations on the scope of the technology. Other objects, aspects, and embodiments will occur to those skilled in the art upon consideration of this specification, and are encompassed within the spirit of the technology as defined by the scope of the claims. It will be readily apparent to one skilled in the art that varying substitutions and modifications can be made to the technology disclosed herein without departing from the scope and spirit of the technology.

The methods, devices and compositions illustratively described herein suitably can be practiced in the absence of any element or elements, or limitation or limitations, which is not specifically disclosed herein as essential. The methods and processes illustratively described herein suitably can be practiced in differing orders of steps, and the methods and processes are not necessarily restricted to the orders of steps indicated herein or in the claims.

Under no circumstances can the patent be interpreted to be limited to the specific examples or embodiments or methods specifically disclosed herein. Under no circumstances can the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the methods, devices and compositions as claimed. Thus, it will be understood that although the present technology has been specifically disclosed by preferred embodiments and optional features, modification and variation of the concepts herein disclosed can be resorted to by those skilled in the art, and that such modifications and variations are considered to be within the scope of this technology as defined by the appended claims and statements of the technology.

The technology has been described broadly and generically herein. Each of the narrower species and subgeneric groupings falling within the generic disclosure also form part of the technology. This includes the generic description of the technology with a proviso or negative limitation removing any subject matter from the genus, regardless of whether or not the excised material is specifically recited herein. In addition, where features or aspects of the technology are described in terms of Markush groups, those skilled in the art will recognize that the technology is also thereby described in terms of any individual member or subgroup of members of the Markush group.

We claim:

1. A composition comprising:
a fabric substrate having a first melting temperature; and
a polymer sheet having a second melting temperature, wherein the second melting temperature is less than the first melting temperature;
wherein the polymer sheet and the fabric substrate are fused by a fusion-bonding process to form a fused laminated fabric, and
wherein the fusion-bonding process includes applying heat and pressure sufficient to at least partially melt the polymer sheet at an interface of the polymer sheet and the fabric substrate such that the polymer sheet penetrates at least partially into the fabric substrate.

2. The composition of claim 1, wherein the polymer sheet includes a hot melt adhesive polymer, a film, web, a resinous sheet, or a combination thereof, and wherein the minimum melt temperature is approximately 60° C.

3. The composition of claim 2, wherein:
the polymer sheet includes a polyamide, a copolyamide or a blend thereof, and the fabric substrate includes a Nylon 66 polymer, a Nylon 66 co-polymer, a Nylon 6 polymer, a Nylon 6 co-polymer, a Nylon 10 polymer, a Nylon 10 co-polymer, a Nylon 12 polymer, a Nylon 12 co-polymer, a Nylon 11 polymer, or a Nylon 11 co-polymer, or a blend thereof; or
the polymer sheet includes a polyester, a polyester copolymer or a blend thereof, and the fabric substrate includes a polyester or a polyester copolymer or a blend thereof; or
the polymer sheet includes a polyolefin, a polyolefin copolymer or a blend thereof, and the fabric substrate includes a polyolefin or a polyolefin copolymer or a blend thereof.

4. The composition of claim 1, wherein the fabric substrate comprises:
the fabric substrate comprises a membrane, non-woven fabric, plain-woven fabric, knitted fabric, fibrous sheet, blended yarn fabric, three-dimensional fabric, embossed fabric, a film, or a resinous sheet; or
the fabric substrate or the polymer sheet or both have an activated or modified surface for improved adhesion created by corona treatment, atmospheric plasma, or dielectric barrier discharge-based atmospheric low temperature plasma; or
a combination thereof.

5. The composition of claim 1, wherein the fabric substrate and the polymer sheet have a base thermoplastic polymer in common, wherein the thermoplastic polymer includes polyethylene terephthalate, polypropylene, polyethylene, or thermoplastic polyamide.

6. The composition of claim 1, wherein the fabric substrate and the polymer sheet have a base thermoplastic polymer in common, wherein the thermoplastic polymer includes thermoplastic polyurethane.

7. The composition of claim 1, wherein the fused laminated fabric is free of external adhesive.

8. The composition of claim 1, wherein the fused laminated fabric is water resistant and wherein a water resistance performance of the fused laminated fabric ranges from approximately 50 mm to approximately 20,000 mm of water by AATCC TM 127-2017(1028)e Water Resistance test method.

9. The composition of claim 1, wherein the fusion-bonding process results in at least partially melting of the polymer sheet and penetration of the polymer sheet into the fabric substrate by about 5% to about 90% of thickness of fabric substrate.

10. The composition of claim 1, wherein a thickness of the polymer sheet is approximately 0.1 mil to approximately 20 mil or approximately 0.5 mil to approximately 10 mil, the polymer sheet is approximately 1% to approximately 40% of a total weight of the fused laminated fabric, or a combination thereof.

11. The composition of claim 1, wherein a difference between the first melting temperature and the second melting temperature is approximately 10° C. to approximately 200° C.

12. A method of making a fused laminated fabric, comprising:
at least partially melting a polymer sheet;
laminating the at least partially melted polymer sheet and a fabric substrate, the fabric substrate having a first melting temperature and the polymer sheet having a second melting temperature, wherein the second melting temperature is less than the first melting temperature; and
fusing the laminated polymer sheet and the fabric substrate by a fusion-bonding process to form the fused laminated fabric,
wherein the fusion-bonding process includes processing at a temperature less than the first melting temperature.

13. The method of claim 12, wherein
the fabric substrate comprises a membrane, non-woven fabric, plain-woven fabric, knitted fabric, fibrous sheet, blended yam fabric, three-dimensional fabric, embossed fabric, a film, or a resinous sheet, or a combination thereof;
the polymer sheet includes a hot melt adhesive polymer, a film, web, a resinous sheet, or a combination thereof;
the fabric substrate and the polymer sheet have a base thermoplastic polymer in common; or
a combination thereof.

14. The method of claim 12, wherein:
the polymer sheet includes a polyamide, a copolyamide or a blend thereof, and the fabric substrate includes a Nylon 66 polymer, a Nylon 66 co-polymer, a Nylon 6 polymer, a Nylon 6 co-polymer, a Nylon 10 polymer, a Nylon 10 co-polymer, a Nylon 12 polymer, a Nylon 12 co-polymer, a Nylon 11 polymer, or a Nylon 11 co-polymer, or a blend thereof; or
the polymer sheet includes a polyester, a polyester copolymer or a blend thereof, and the fabric substrate includes a polyester or a polyester copolymer or a blend thereof; or
the polymer sheet includes a polyolefin, a polyolefin copolymer or a blend thereof, and the fabric substrate includes a polyolefin or a polyolefin copolymer or a blend thereof.

15. The method of claim 12, wherein the fused laminated fabric is water resistant, wherein a water resistance performance of the fused laminated fabric ranges from approximately 50 mm to approximately 20,000 mm of water by AATCC TM 127-2017(1028)e Water Resistance test method.

16. The method of claim 12, wherein the thickness of the polymer sheet is approximately 0.1 mil to approximately 20 mil, the polymer sheet is approximately 1% to approximately 40% of the total weight of the fused laminated fabric, or a combination thereof.

17. The method of claim 12, wherein the fusion-bonding process results in at least partially melting of the polymer sheet and penetration of the polymer sheet into the fabric substrate by about 5% to about 90% of thickness of fabric substrate.

18. A method of making a textile article, comprising:
receiving a fragmented material, wherein the fragmented material includes a fused lamination of a fabric substrate having a first melting temperature and a polymer sheet having a second melting temperature,
wherein the second melting temperature is less than the first melting temperature; and
fabricating the textile article, wherein the textile article includes the fragmented material.

19. The method of claim 18, wherein:
the fragmented material is in the form of strips, granules, or pellets;
the textile article includes a yarn, a sheet, a spun fabric, a fiber, a film, a resinous sheet, or an injection molded article; or
a combination thereof.

20. The method of claim 18, wherein the textile article includes mechanically recycled fragmented material or chemically recycled fragmented material, wherein the chemically recycled fragmented material optionally includes a pyrolyzed fragmented material.
